(19) United States
(12) Patent Application Publication
(10) Pub. No.: US 2024/0029224 A1
(43) Pub. Date: Jan. 25, 2024

(54) METHODS AND SYSTEMS FOR MURA DETECTION AND DEMURA

(71) Applicant: JADE BIRD DISPLAY (SHANGHAI) LIMITED, SHANGHAI (CN)

(72) Inventor: Xingtong JIANG, Shanghai (CN)

(21) Appl. No.: 18/352,369

(22) Filed: Jul. 14, 2023

(30) Foreign Application Priority Data
Jul. 25, 2022 (WO) PCT/CN2022/107684

(51) Int. Cl. G06T 7/00; G06T 7/90; G06T 15/50; G06T 5/00

(52) U.S. Cl. CPC G06T 7/0002; G06T 7/90; G06T 15/50; G06T 5/002; G06T 2215/16; G06T 2207/30168; G06T 2207/10024

(57) ABSTRACT

A method for detecting a mura of a virtual image in a near-eye display and a method for demura are provided. The method for detecting a mura includes acquiring the virtual image rendered in the near-eye display; extracting a mura feature of the virtual image according to a mura type; and evaluating a mura degree of the virtual image based on the mura type. The method for demura includes acquiring a mura feature of a first virtual image rendered in the near-eye display; calculating a compensation factor based on the mura feature; and adjusting a gray scale value of the near-eye display based on the compensation factor to obtain a second virtual image.

### CROSS-REFERENCE TO RELATED APPLICATIONS

The present disclosure claims priority to and the benefits of PCT Application No. PCT/CN2022/107684, filed on Jul. 25, 2023, which is incorporated herein by reference in its entirety.

### TECHNICAL FIELD

The present disclosure generally relates to micro display technology, and more particularly, to a demura system and method for a virtual image rendered in near-eye displays.

BACKGROUND

A micro light emitting diode (LED) display panel has advantages of smaller size, higher refreshing rate, and higher brightness. However, the micro LED display panel suffers from mura such as a non-uniformity of the micro LED display panel due to production process or long operation time, or the like, resulting in a residual image, mottled, bright or black spot, or cloud appearance, which reduces the quality level of the micro LED display panel. The non-uniformity of the display panel may be usually compensated by a demura method. A demura method is used to remove the non-uniformity or improve a uniformity of a LED display panel. The non-uniformity of the micro LED display panel is conventionally directly compensated by adjusting gray scale values of pixels in the micro LED display panel.

Near-eye displays may be provided as AR, VR, Head Up/ Head Mount or other displays. Generally, a near-eye display usually comprises an image generator and an optical combiner which transfers a projected image from the image generator to human eyes. Furthermore, the projected image is a virtual image before human eyes. The image generator can be a micro LED based display, a LCOS (Liquid Crystal on Silicon) display, or a DLP (Digital Light Processing) display. The aforementioned mura of the micro LED display panel may affect the final virtual image quality which is transferred to human eyes. A source image presents variation in brightness and color among the pixels seen as the non-uniformity in the distribution in luminance and/or chromaticity. Non-uniformity originating from the image generator also causes non-uniformity on the final rendered virtual image. Mura present as the non-uniformity of the displays, can be observed by human vision. Therefore, mura is a vital visual artefact for displays. Moreover, compared to traditional displays, the non-uniformity artefacts of the near-eye displays are much more obvious due to being close to human eyes. However, to the manner of detecting the mura and applying demura in the final rendered virtual image for the near-eye displays is needed.

### SUMMARY OF THE DISCLOSURE

Embodiments of the present disclosure provide a method for detecting a mura of a virtual image in a near-eye display. The method includes acquiring the virtual image rendered in the near-eye display; extracting a mura feature of the virtual image according to a mura type; and evaluating a mura degree of the virtual image based on the mura type.

Embodiments of the present disclosure further provide a system for detecting a mura in a virtual image rendered in a near-eye display. The system includes: an image generator configured to render a virtual image; an imager configured to acquire the virtual image; a positioner coupled with the image generator and the imager, and configured to control a relative position of the near-eye display and the imager; and a processor coupled with the imager and configured to evaluate a mura degree of the virtual image.

### BRIEF DESCRIPTION OF THE DRAWINGS

Embodiments and various aspects of the present disclosure are illustrated in the following detailed description and the accompanying figures. Various features shown in the figures are not drawn to scale.

FIG. 1 is a schematic diagram of an exemplary demura system according to some embodiments of the present disclosure.

FIG. 2 shows a flowchart illustrating an exemplary demura method, according to some embodiments of the present disclosure.

FIG. 3 illustrates an exemplary demura process according to some embodiments of the present disclosure.

FIG. 4 is a schematic block diagram of an exemplary demura system, according to some embodiments of the present disclosure.

FIGS. 5A-5C show different types of mura features respectively, according to some embodiments of the present disclosure.

FIG. 6 shows a flowchart illustrating an exemplary mura extraction method, according to some embodiments of the present disclosure.

FIG. 7 shows a flowchart illustrating an exemplary demura method, according to some embodiments of the present disclosure.

FIG. 8 illustrates an exemplary demura process, according to some embodiments of the present disclosure.

### DETAILED DESCRIPTION

Reference will now be made in detail to exemplary embodiments, examples of which are illustrated in the accompanying drawings. The following description refers to the accompanying drawings in which the same numbers in different drawings represent the same or similar elements unless otherwise represented. The implementations set forth in the following description of exemplary embodiments do not represent all implementations consistent with the invention. Instead, they are merely examples of apparatuses and methods consistent with aspects related to the invention as recited in the appended claims. Particular aspects of the present disclosure are described in greater detail below. The terms and definitions provided herein control, if in conflict with terms and/or definitions incorporated by reference.

To improve image quality, a demura for near-eye displays is required. The demura refers to a process for eliminating/suppressing the visual artefacts and achieving relative uniformity for the luminance and/or color in a display.

In some embodiments, systems and methods for detecting mura and performing demura for near-eye displays are provided.

Since mura refers to a non-uniformity in luminance and/or chromaticity, that is seen as a visual artifact by human eyes, mura features need to be extracted for evaluating and further for suppressing the visual artefact. The mura features can be extracted by analyzing profiles such as luminance scale, gradient boundary/frequency domain, or grayscale histogram. Mura features can be identified as three types: a corner mura, a cloud mura, and a global mura. For evaluation, the mura can be classified in various levels according to human sensitivity to determine a primary mura type. For example, human eyes are more sensitive to a corner effect than a cloud effect, and are more sensitive to a cloud effect than to a global non-uniformity. Therefore, the corner mura can be determined as a primary mura for evaluation. In some embodiments, the mura can be classified according to mura degree of each mura type. For example, if the mura degree of a cloud mura is greater than the mura degree of a corner mura, the cloud mura is determined as the primary mura. In some embodiments, the classification is defined by a user. For example, a global non-uniformity mura may be set as primary mura by user for certain images. In some embodiments, one or more mura types can be determined as primary mura for evaluation. For example, both the corner mura and the cloud mura may be determined as primary muras, so that both the corner mura and cloud mura are evaluated to obtain a final mura degree.

Based on the extracted and identified mura features, compensation can be performed to achieve a relative uniform distribution of a displayed image by adjusting a matrix gray-value of an image generator (e.g., an image generator of a near-eye display). Compensation factors can be calculated as an inverse of the variation in luminance and/or chromaticity according to a baseline threshold. The baseline threshold can be determined by a matrix gray-value histogram. In the histogram, an amount proportion distribution in all gray values (e.g., 0-255) is calculated. The peak as the maximum amount of a gray value is extracted. For example, the maximum amount proportion is 0.2 and corresponding gray value is 87. That means the majority of this image gray value is 87. Then, the majority gray value is determined as the baseline threshold for the compensation. This is the histogram approach in determining baseline for compensation. It is noted that not all the mura features are considered to calculate compensation factors. For example, the identified mura features are evaluated as candidates for compensation factor calculation. The calculation of compensation factors can be based on mura features which are selected from the candidates, i.e., the identified mura features. A display driving capability with sufficient range (e.g., additional 100% gray scale adjustment space) can also be considered in a compensation tolerance for calculating compensation factors. The compensation tolerance here means the limitation in compensation during operation. For example, a normal operation is 8 bits with range of 0-255 gray values. With additional one bit, the system can operate in a range of 0-511 gray values (9 bits), with one time (100%) compensation ability. However, if the compensation factor is two or more times (e.g., 200-300%), then it is out of the operation range (e.g., 9 bits), so that the compensation factor is always cut off at the maximum compensation tolerance (100%) and the gray scale is unable to further adjusted to an expectation. That is, the calculation of the compensation factor shall take the display driving ability into account. After the compensation, the mura (i.e., non-uniformity) can be reviewed/re-evaluated to determine whether the compensated image satisfies human sensitivity. This compensation process is referred to herein as a demura process. It should be noted that the term of compensation is equivalent to term of correction, and compensation factors mean correction coefficients in the present disclosure. The mura in herein also refers a local and global nonuniformity. The demura can be interpreted as nonuniformity correction or compensation.

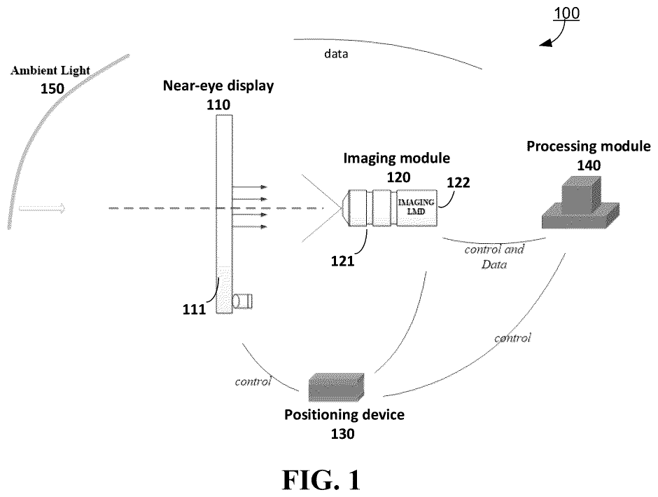

FIG. 1 is a schematic diagram of an exemplary demura system 100 according to some embodiments of the present disclosure. As shown in FIG. 1, system 100 is provided to detect mura/non-uniformity of a virtual image rendered in a near-eye display. System 100 includes a near-eye display (NED) 110 for displaying images before human eyes, an imager provided as an imaging module 120, a positioner provided as a positioning device 130, and a processor provided as a processing module 140. Additionally, ambient light can be provided by ambient light module 150. Near-eye display 110 can be provided as an AR, VR, Head Up/Head Mount display or other displays. Positioning device 130 is provided to set an appropriate spatial relation between near-eye display (NED) 110 and imaging module 120. For example, positioning device 130 is configured to set a distance between near-eye display 110 and imaging module 120 in a range of 10 mm-25 mm. Positioning device 130 can further adjust the relative position (e.g., the distance and spatial position) of near-eye display 110 and imaging module 120. Imaging module 120 is configured to emulate the human eye to measure display optical characteristics and to observe display performance. In some embodiments, imaging module 120 can include an array light measuring device (LMD) 122 and a near-eye display (NED) lens 121. For example, LMD 122 can be a colorimeter or an imaging camera, such as a CCD (charge coupled device) or a CMOS (complementary metal oxide semiconductor). Near-eye display (NED) lens 121 of imaging module 120 is provided with a front aperture having a small diameter of 1 mm-6 mm. Therefore, near-eye display (NED) lens 121 can provide a wide view field (e.g., 60-180 degrees) in front, and near-eye display lens 121 is configured to emulate a human eye to observe near-eye display 110. The optical property of the virtual image is measured by imaging module 120 based on positioning device 130.

In some embodiments, near-eye display 110 can include an image generator 111 also referred to herein as an image sourcer and an optical combiner also referred to herein as image optics (not shown in FIG. 1). Image generator 111 can be a micro display such as a micro-LED, micro-OLED, LCOS, or DLP display, and can be configured to form a light engine with an additional projector lens. The projected image from the light engine through designed optics is transferred to human eyes through the optical combiner. The optics of the optical combiner can be reflective and/or diffractive optics, such as a free form mirror/prism, birdbath or cascaded mirrors, grating coupler (waveguide), etc.

Processing module 140 is configured to analyze the mura, extract mura features, and calculate compensation factors, etc. In some embodiments, processing module 140 can be included in a computer or a server. In some embodiments, processing module 140 can be deployed in the cloud, which is not limited herein.

In some embodiments, a driver provided as a driving module (not shown in FIG. 1) can be further provided to compensate image generator 111 to remove the mura in the virtual image for display. The compensation factors are calculated in processing module 140, and then transferred to the driving module. Therefore, with system 100, a demura can be performed. The drive system can be coupled to communicate with near-eye display 110, specifically to communicate with image generator 111 of near-eye display 110. For example, the driving module can be configured to adjust the gray scale values of image generator 111. When the driving system including display driving and function of compensation (gray value adjustment in image processing) is integrated in the near-eye display, the data of compensation factors from processing module 140 can be transferred to the near-eye display system 110.

In some embodiments, for example for an AR application, ambient light is provided from ambient light module 150. The ambient light module 150 is configured to generate a uniform light source with corresponding color (such as D65), which can support a measurement taken under an ambient light background, and simulation of various scenarios such as daylight, outdoor, or indoor.

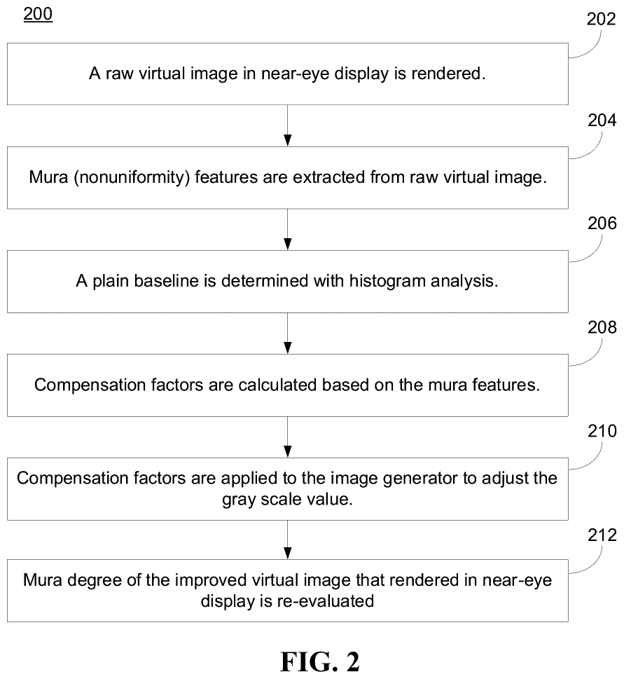

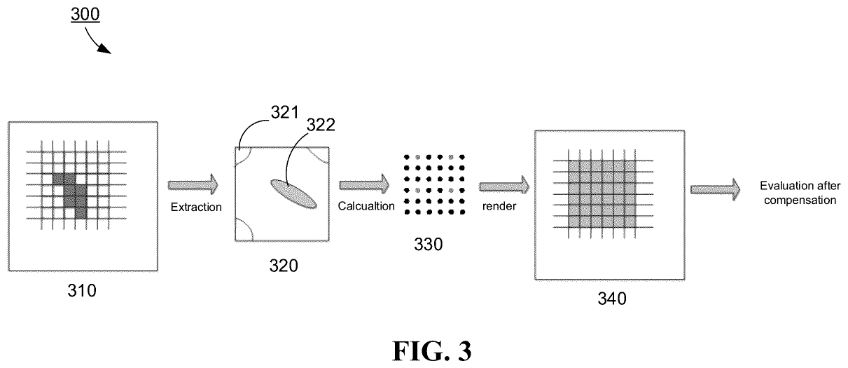

FIG. 2 shows a flowchart illustrating an exemplary demura method 200, according to some embodiments of the present disclosure. FIG. 3 illustrates an exemplary demura process 300 according to some embodiments of the present disclosure. Method 200 can be performed by demura system 100. Referring to FIG. 2 and FIG. 3, demura method 200 includes steps 202 to 212.

At step 202, a raw virtual image is rendered in near-eye display. Rendering refers to a process in the generation of a two-dimensional or three-dimensional image from a model by means of application programs, which is not limited herein. A raw virtual image 310 is rendered from modules, for example, AR module, in a near-eye display, e.g., near-eye display 110. Then raw virtual image 310 is generated by an image generator of the near-eye display, and projected through combiner optics confronting human eyes. Raw virtual image 310 can be captured by an imaging module, e.g., image module 120, for analysis. In practical, there may be multiple virtual images which are rendered in a display for Mura/nonuniformity analysis, under multiple test patterns with various gray values. In some embodiments, a raw virtual image is rendered under an ambient light condition such as D65 daylight scenario, through an ambient-light module (e.g., ambient-light module 150 shown in FIG. 1).

At step 204, mura features 320 are extracted from raw virtual image 310. Mura features 320 can be extracted by analyzing profiles of raw virtual image 310. The profiles can include luminance scale, gradient boundary/frequency domain, or grayscale histogram. The mura features can be further identified as a corner mura 321, a cloud mura 322, or a global mura (i.e., global non-uniformity).

At step 206, a plain baseline is determined by histogram analysis. The plain baseline which can also refer to a baseline threshold, can be determined by a matrix histogram.

At step 208, compensation factors are calculated based on the mura features. The compensation factors can be calculated based further on the plain baseline and self-definition (e.g., a mean value in a local or a global zone). A self-defined compensation target/basic may consider a means value in a local or global zone. The compensation factors can be calculated by comparing the mura features and the plain baseline, further in consideration of a compensation tolerance (e.g., one time compensation ability). In some embodiments, not all the mura features are used to calculate the compensation factors. For example, only mura features identified at step 204 are evaluated as candidates for compensation factor calculations.

At step 210, compensation factors 330 are applied to the image generator to adjust the gray scale value. In some embodiments, the compensation factors 330 are applied in a pixel pipeline of the image generator. For example, compensation factors can be applied in the pixel pipeline of a micro LED display. Different pixels may correspond to different compensation factors. Therefore, the image displayed by micro LED display can be improved pixel-by-pixel.

At step 212, a mura (non-uniformity) degree of the virtual image improved by compensation that rendered in the near-eye display is re-evaluated. The virtual image after compensation is rendered to obtain an improved virtual image 340. The mura degree of the improved virtual image 340 is diminished compared with raw virtual image 310 and can be re-evaluated. When evaluated, the mura can be classified in various levels according to human sensitivity as described above. For example, human eyes are more sensitive to a corner effect than a cloud effect, and more sensitive to a cloud effect than a global non-uniformity. Therefore, the corner mura can be determined as a primary mura type to be evaluated.

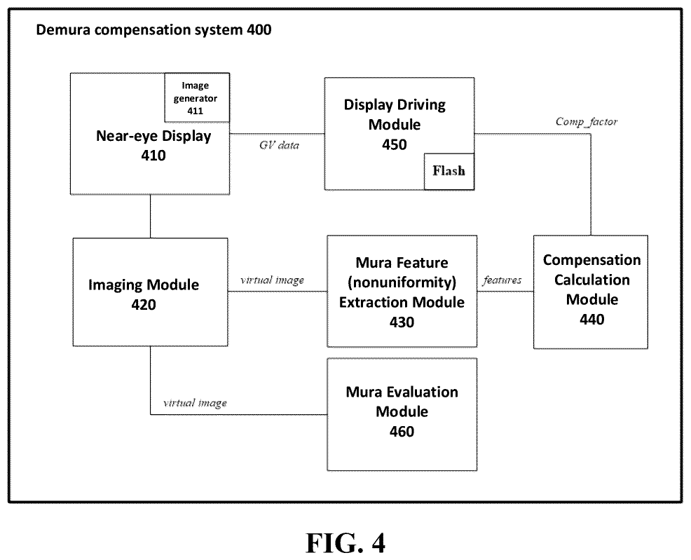

FIG. 4 is a schematic block diagram of an exemplary demura system 400, according to some embodiments of the present disclosure. Demura system 400 can be configured to perform demura method 200 shown in FIG. 2. As shown in FIG. 4, demura system 400 includes a near-eye display 410 for displaying images for human eyes, an imager provided as an imaging module 420, a mura feature extractor provided as a mura feature extraction module 430, a compensation calculator provided as a compensation calculation module 440, a driver provided as a display driving module 450, and an evaluator provided as an evaluation module 460.

Near-eye display 410 can include an image generator (or an image source) 411 and an optical combiner (or image optics). Image generator 411 can be a micro display such as a micro-LED (μLED) display, micro-OLED, LCOS, or DLP display, and can be configured to form a light engine with an additional projector lens. The projected image from the light engine through designed optics is transferred to human eyes through the optical combiner. The optics can be reflective and/or diffractive optics, such as free form mirror/prism, birdbath or cascaded mirrors, grating coupler (waveguide), etc.

Imaging module 420 can include an array light measuring device (LIVID) and a near-eye display lens. For example, the LMD can be colorimeter or imaging camera CCD/CMOS. The near-eye display lens is provided with a front aperture having a small diameter of 1 mm-6 mm. The near-eye display lens provides a wide view field (e.g., 60 to 180 degrees) in front, and is configured to emulate a human eye to observe near-eye display 410. Imaging data of the virtual image can be acquired by imaging module 420 from the virtual image. The imaging data can include luminance, chromaticity, gray scale value, etc. It should be noted that a normal lens together with a camera can be also used to take a relative value in measurement (e.g., uniformity).

Mura feature extraction module 430 is configured to analyze a rendered virtual image with respect to luminance and/or chromaticity or XYZ intensity of a polychrome virtual image based on the acquired imaging data. Mura feature extraction module 430 is coupled to communicate with imaging module 420 to extract the mura features from the virtual image captured by imaging module 420.

Compensation calculation module 440 is coupled to communicate with mura feature extraction module 430 and configured to calculate compensation factors. Compensation calculation module 440 can be configured to calculate the compensation factors based on the mura features extracted by mura feature extraction module 430. The compensation factors can be calculated based further on the plain baseline and self-definition (e.g., a mean value in a local or a global zone). The compensation factors can be calculated by comparing the mura features and the plain baseline, further in consideration of a compensation tolerance (e.g., one time compensation ability). In some embodiments, not all the mura features are used to calculate the compensation factors. For example, only the identified mura features are evaluated as candidates for compensation factor calculations.

Display driving module 450 is coupled to communicate with compensation calculation module 440 and further coupled to communicate with near-eye display 410. Display driving module 450 is configured to adjust the gray scale value for an image source, for example, image generator 411. In some embodiments, display driving module 450 is configured to apply the compensation factors calculated by compensation calculation module 440 in a pixel pipeline of image generator 411, which is included in near-eye display 410. For example, compensation factors can be applied in the pixel pipeline of a micro LED display. Different pixels may correspond to different compensation factors.

Mura evaluation module 460 is coupled to communicate with the imaging module 420, and configured to evaluate a mura degree (e.g., degree of non-uniformity) after the compensation. After the compensation, a virtual image is rendered again in near-eye display 410 to obtain an improved virtual image which can be captured by imaging module 420. Then, mura evaluation module 460 can evaluate the mura degree of the improved virtual image captured by imaging module 420. In some embodiments, mura evaluation module 460 can be further configured to classify the mura. The mura can be classified in various level according to human sensitivity to determine a primary mura type. For example, as described above, human eyes are more sensitive to a corner effect than a cloud effect, and more sensitive to a cloud effect than a global non-uniformity. Therefore, the corner mura can be determined as a primary mura for evaluation. In some embodiments, the mura can be classified according to mura degree of each mura type. For example, if the mura degree of cloud mura is greater than the mura degree of corner mura, the cloud mura is determined as the primary mura. In some embodiments, the classification is defined by a user. For example, the global mura may be set as primary mura by a user for certain images. In some embodiments, one or more mura types can be determined as primary mura for evaluation. For example, both corner mura and cloud mura may be determined as primary mura, and then both the corner mura and cloud mura are evaluated to obtain a final mura degree.

Therefore, with the evaluation, it can be determined that the mura degree of improved virtual image 340 is diminished compared with the mura degree of raw virtual image 310.

In some embodiments, demura system 400 further includes a preprocessing module (e.g., a preprocessor) coupled with imaging module 420 and mura feature extraction module 430. The preprocessing module is configured to perform preprocessing on the raw virtual image before the mura feature extraction. In some embodiments, in the preprocessing, negative influences which deteriorates image quality such as noise or distortion in the raw virtual image are eliminated. In some embodiments, in the preprocessing, a mapping/registration from the pixel matrix of virtual image to source pixel matrix (image generator) is applied. For example, a pixel matrix of virtual image of 10,000×10,000 is translated to a source pixel matrix of 640×480 of image generator. Optionally, the mapping/registration can be performed by the compensation factor calculation module 440 for further gray value adjustment in the compensation process.

It can be understood that the connections between the above-mentioned modules can be wired communication or wireless communication, for example via internet, Bluetooth, etc., which is not limited herein. In some embodiments, mura feature extraction module 430, compensation calculation module 440, display driving module 450, mura evaluation module 460, and the preprocessing module, can be integrated in a computer system or a server or deployed in the cloud, which will not limit herein.

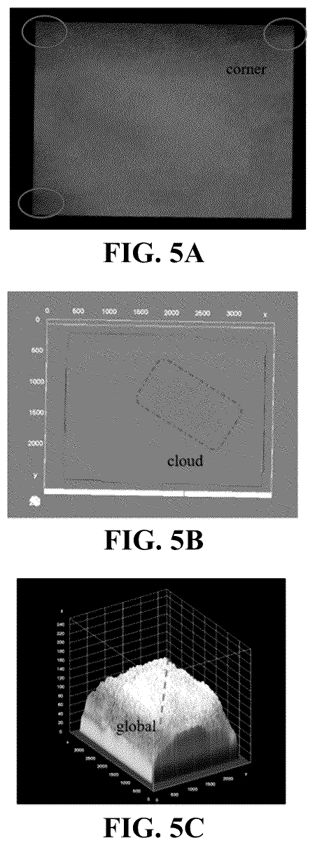

In some embodiments, the virtual image rendered by near-eye display 410 is obtained from imaging module 420, in which some apparent artefacts can be directly shown. FIGS. 5A-5C show different types of mura features, respectively, according to some embodiments of the present disclosure. FIG. 5A shows an obvious dark region at each of three corners of an image, which are referred to herein corner features. FIG. 5B shows a raw image translated to a pseudo-color image which presents an absolute/relative luminance distribution. As shown, on the local region delineated by a dot-dash line, a cloud area is shown apparently floating on a global plane, which constitutes a cloud feature. FIG. 5C shows a raw image plotted in as a 3D surface to obtain a 3D image. As shown, beside the corner and cloud artefact zones, the 3D surface gradually decays in multiple directions, which refers to global mura. Therefore, the non-uniformity on the global surface is observable. The gradual surface decay of the 3D image can be extracted as the mura feature. In an example of a waveguide, the light can decay from one corner in the direction of others corners. Since the human eye is sensitive to mura artefacts, these are also non-uniformities that may occur in the virtual image.

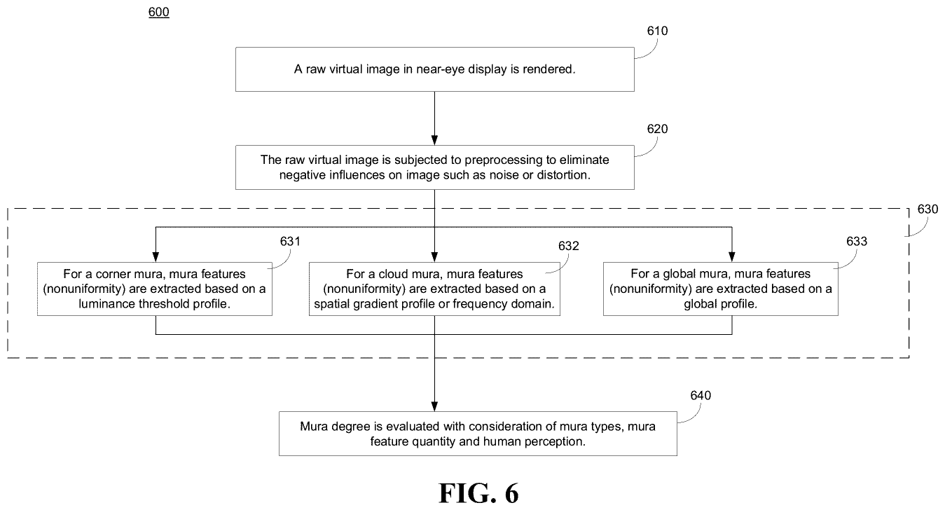

In order to extract the mura features in the rendered virtual image, a method for extracting mura features is provided. FIG. 6 shows a flowchart illustrating an exemplary mura extraction method 600, according to some embodiments of the present disclosure. Referring to FIG. 6, mura extraction method 600 includes steps 610 to 640.

At step 610, a raw virtual image in a near-eye display is rendered. The raw virtual image with mura is rendered from models, for example, AR models. Then the raw virtual image is displayed by an image generator of the near-eye display, and projected through combiner optics in front of human eyes. The raw virtual image can be captured by imaging module, e.g., imaging module 120 or 420, for analysis. In some embodiments, a raw virtual image is rendered under an ambient light condition such as D65 daylight scenario.

At step 620, the raw virtual image is subjected to preprocessing to eliminate negative influences such as noise or distortion. The raw virtual image can be captured by the imaging module (e.g., an array light measuring device (LIVID) and a near-eye display lens) under full white and/or gray test patterns. Then, the preprocessing is performed on the captured raw virtual image. In some embodiments, in the preprocessing, the negative influences which deteriorates image quality such as noise or distortion in the raw virtual image are eliminated. The distortion including a camera lens or a NED optical module are considered in the procedure.

At step 630, mura features are extracted based on mura types. The mura type includes corner mura, cloud mura, and global mura (or global non-uniformity). For different mura types, the mura features can be extracted with different profiles. It is worthy to mention that the appearance of cloud form mura refers to a region of nonuniformity. The region of nonuniformity could also be a spot or other description. Here, cloud mura is used to describe the general region of nonuniformity, and also cloud mura also refers a similar region form such as spot.

More specifically, step 630 can further include steps 631 to 633.

At step 631, for a corner mura, mura features are extracted with a luminance threshold profile. For example, the luminance profile of the image is compared with a luminance threshold profile. The threshold may be an upper and/or lower threshold. If the luminance in a corner exceeds (or falls below) the luminance threshold corresponding to the corner, for example, the luminance in the corner is greater (or less) than the luminance threshold corresponding to the corner, the corner mura features are extracted.

At step 632, for a cloud mura, mura features are extracted with a spatial gradient profile or frequency domain. For example, the spatial gradient profile can be applied to extract the mura features. In some embodiments, a region variation scale, can be obtained according to the spatial gradient profile. Mura features can be extracted by comparing the region variation scale with a preset threshold. In some embodiments, the captured image can be transformed to the frequency domain for further filtering in human contrast sensitivity perception, and extract the visual nonuniformity information.

At step 633, for a global mura, mura features are extracted with a global profile (e.g., histogram), for example, a grayscale histogram. The histogram can be applied as a profile for analyzing the non-uniformity as the baseline. For example, through image histogram, the most amount proportion of the gray value (i.e., peak) is extracted as the majority representation of the image, and is as the baseline analysis for image uniformity. It is also note that a gradient, including scale and direction, in the full field can be considered in the global nonuniformity analysis as well.

At step 640, a mura degree is evaluated with consideration of mura types, mura feature quantity, and human perception. The mura types may refers corner mura, cloud/spot mura, or global mura. For a mura, an evaluation is not only performed in types but also in quantity. The quantity means a degree of scale of nonuniformity, for example, a percentage of difference scale. For example, an 8% difference scale is serious than 5%. Human eyes have relative sensitivity for the nonuniformity. For example, when the difference/nonuniformity is smaller than 1%, the difference/nonuniformity is not apparently/visible to human eyes. After obtaining the mura features, an evaluation can be performed to determine the mura degree in the near-eye display. Mura can be classified in various levels according to human sensitivity to determine a primary mura type. For example, as described above, human eyes are more sensitive to a corner effect than a cloud effect, and more sensitive to a cloud effect than a global non-uniformity. Therefore, the corner mura can be determined as a primary mura for evaluation. In some embodiments, the mura can be classified according to mura degree of each mura type. For example, if the mura degree of a cloud mura is greater than the mura degree of a corner mura, the cloud mura is determined as the primary mura. In some embodiments, the classification is defined by the user. For example, the global mura may be set as primary mura by the user for certain images. In some embodiments, one or more mura types can be determined as primary mura for evaluation. For example, if both corner mura and cloud mura are determined as primary mura, then both the corner mura and cloud mura are evaluated to obtain a final mura degree. A luminance scale or area size (e.g., 30% area of the image) can be set as a threshold to evaluate the mura degree. For example, for a corner mura, the luminance scale is set as a threshold. For a cloud mura, the area size is set as the threshold. In some embodiments, a quantitative evaluation can be made depending on the human perception. For example, when the luminance difference less than 1%, the luminance difference is not apparent/visible to human eyes.

The mura of the polychrome virtual image rendered in a near-eye display are also considered. For each individual primary color channel, the mura occurs on the image surface after the light spreads in path. Image light is generated in micro displays, transmitted through lens of light engine/projector, and further transmitted through optical combinator (such as waveguide) until finally received by human eyes, which refers to the light spreading in path. The mura features are the same as those described above, which will not further repeat herein. Moreover, for three primary color channels (e.g., RGB), each color channel has its own mura types and scales. For a channel, the features can include one or more mura types. The scale for each channel can be vary. For example, for a global decay from one corner to the other three corners of a virtual image, the variation can be from 30%-80%. Therefore, the serious issues such as color shift and white balance are raised, except the luminance nonuniformity.

To solve these issues, for color correction, a demura method depending on a doping ratio upon three primary color channels is provided. The doping is made in driving displays.

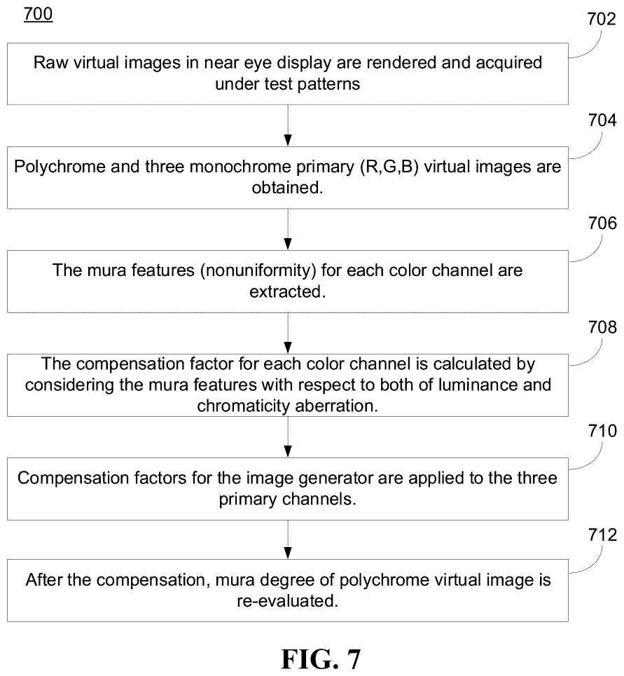

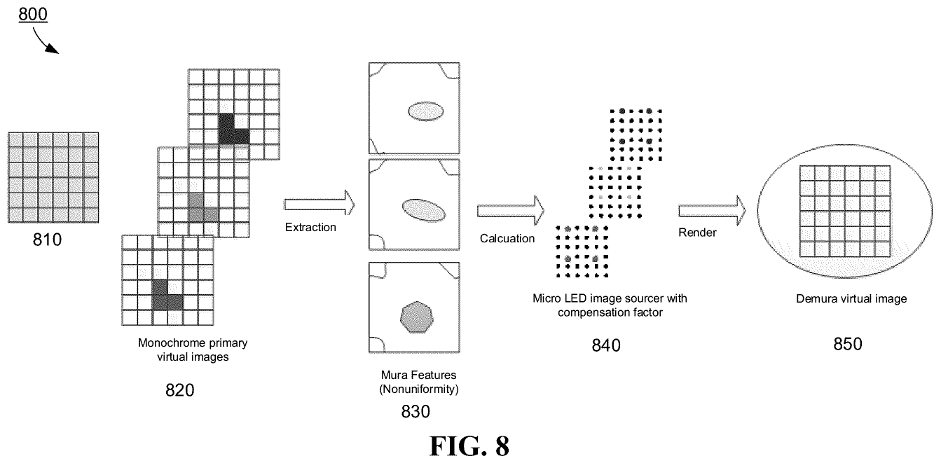

In some embodiments, a method for demura is provided. FIG. 7 shows a flowchart illustrating an exemplary demura method 700, according to some embodiments of the present disclosure. FIG. 8 illustrates an exemplary demura process 800, according to some embodiments of the present disclosure. Referring to FIG. 7 and FIG. 8, the demura method 700 includes steps 702 to 712.

At step 702, a raw virtual image 810 in a near-eye display is rendered and acquired under test patterns. The test patterns can be a full solid test patterns with various gray values (e.g., 63, 127, 255 etc.). Multiple test patterns may be applied in measurement with various gray value and colors. Each test pattern can be in one or more color such as R/G/B pattern and/or a white image. It is worthy to mention that partial on/off pixel test patterns can be used in the measurement instead of a full solid pattern directly. That means multiple partial on/off patterns can be used in the measure and finally integrated in to one full solid image. The raw virtual image is displayed by an image generator of the near-eye display, and projected through combiner optics in front of human eyes. The raw virtual image can be captured by an imaging module for analysis. In some embodiments, the raw virtual image is rendered under an ambient light condition such as D65 daylight scenario.

In some embodiments, a polychrome virtual image is acquired under white test pattern.

At step 704, three monochrome primary (R, G, B) and polychrome virtual images are obtained 820. An image can include RGB three primary images, which are red, green and blue images. Each monochrome primary virtual image corresponds to one channel. Therefore, the three monochrome virtual images are captured under three color test patterns, and imaging data of the monochrome virtual images can be acquired. The polychrome (white) virtual image is also obtained in the procedure.

At step 706, the mura features for each color channel are extracted 830. For each monochrome virtual image, the mura features are extracted. The mura features can be extracted based on mura types, such as corner mura, cloud mura, and global mura. More specifically, for a corner mura, mura features are extracted based on a luminance threshold profile. For a cloud mura, mura features are extracted based on a spatial gradient profile or frequency domain. For a global mura, mura features are extracted based on a global profile (e.g., histogram), for example, grayscale histogram. More details about the mura features extraction are described above with reference to method 600 described above, which will not be repeated herein.

At step 708, the compensation factor for each color channel is calculated by considering the mura features with respect to both of luminance and chromaticity nonuniformity. The compensation factors for each channel can be calculated according to individual rendered virtual images. In some embodiments, individual differences among the three channels are considered for calculating the compensation factors. For example, a color shift based on differences among the monochrome virtual images to a whole white virtual image in the full field is obtained. The whole white virtual image is formed by overlying all of the monochrome virtual images together. In some embodiments, the compensation factors are calculated depending on a doping ratio among three channels. The doping ratio means a proportion between three primary color channels of red, green and blue. Therefore, the compensation factors can be further used to correct color and/or white balance through adjusting the doping ratio for each pixel in matrix and global tone.

At step 710, compensation factors for the image generator are applied to the three primary color channels 840. For example, the gray scale value of a virtual image in the image generator (e.g., micro LED display, micro display) is adjusted depending on the compensation factor for each channel.

At step 712, after the compensation, a mura degree of the polychrome virtual image is re-evaluated 850. After compensation is applied on the image data of the raw virtual image, the rendered virtual image is reevaluated to determine if the non-uniformity/mura has been successfully eliminated. In some embodiments, the mura evaluation can be performed in both of luminance and color. Since a large scale mura has been suppressed, human eyes should not be sensitive to the remaining mura.

The embodiments may further be described using the following clauses:
1. A method for detecting a mura of a virtual image in a near-eye display, comprising:
   acquiring the virtual image rendered in the near-eye display;
   extracting a mura feature of the virtual image according to a mura type; and
   evaluating a mura degree of the virtual image based on the mura type.
2. The method according to clause 1, wherein the mura type comprises a corner mura, a cloud mura, or a global mura.
3. The method according to clause 2, wherein extracting the mura feature of the virtual image according to the mura type, comprises:
   extracting, when the mura type is the corner mura, the mura feature based on a luminance threshold profile.
4. The method according to clause 2, wherein extracting the mura feature of the virtual image according to the mura type, comprises:
   extracting, when the mura type is the cloud mura, the mura feature based on a spatial gradient profile or frequency domain.
5. The method according to clause 2, wherein extracting the mura feature of the virtual image according to the mura type, comprises:
   extracting, when the mura type is the global mura, the mura feature based on a global profile.
6. The method according to clause 2, wherein before extracting the mura feature of the virtual image according to the mura type, the method further comprises:
   translating the virtual image into a pseudo-color image, wherein the pseudo-color image presents an absolute luminance distribution or a relative luminance distribution.
7. The method according to clause 2, wherein before extracting mura features of the virtual image based on the mura type, the method further comprises:
   plotting the virtual image as a 3D surface to obtain a 3D image.
8. The method according to any one of clauses 2 to 7, wherein evaluating the mura degree of the virtual image based on the mura type, further comprising:
   determining one or more primary mura types of the virtual image; and
   evaluating the mura degree of the virtual image based on one or more preset thresholds corresponding to the one or more primary mura types.
9. The method according to clause 8, wherein the corner mura is determined as the primary mura type.
10. The method according to clause 9, wherein the one or more preset thresholds comprises:
   a luminance scale threshold corresponding to the corner mura, or an area size threshold corresponding to the cloud mura.
11. The method according to clause 10, wherein the preset threshold of the luminance scale threshold is 30%, and the preset threshold of the area size threshold is 30%.
12. The method according to any one of clauses 1 to 11, wherein acquiring the virtual image rendered in the near-eye display, further comprises:
   acquiring the virtual image under a solid test pattern or multiple partial test patterns, wherein the partial test patterns are with various gray values and colors.
13. The method according to clause 12, wherein the test pattern is a full white test pattern.
14. The method according to clause 12, wherein the test pattern is a full gray test pattern.
15. The method according to clause 12, wherein the virtual image is rendered under an ambient light condition.
16. The method according to any one of clauses 1 to 15, wherein before extracting the mura feature of the virtual image according to the mura type, the method further comprises:
   preprocessing the virtual image by eliminating one or more of a noise or a distortion.
17. A method for demura of a virtual image rendered by a near-eye display, comprising:
   acquiring a mura feature of a first virtual image rendered in the near-eye display; calculating a compensation factor based on the mura feature; and
   adjusting a gray scale value of the near-eye display based on the compensation factor to obtain a second virtual image.
18. The method according to clause 17, further comprising:
   evaluating a mura degree of the second virtual image.
19. The method according to clause 17 or 18, wherein acquiring the mura feature of the first virtual image further comprises:
   acquiring monochrome virtual images for different colors; and
   acquiring the mura feature of each of the monochrome virtual images.
20. The method according to clause 19, wherein calculating the compensation factor based on the mura feature, further comprises:
   calculating the compensation factor based on the mura feature for each monochrome virtual image.
21. The method according to clause 20, wherein calculating the compensation factor based on the mura feature, further comprises:
   applying a mapping from a pixel matrix of the first virtual image to a source pixel matrix.
22. The method according to clause 19, wherein calculating the compensation factor based on the mura feature further comprises:
   obtaining a color shift based on a difference among the monochrome virtual images on a whole virtual image; and
   determining the color shift as the mura feature.
23. The method according to clause 22, wherein the difference is a doping ratio among the monochrome virtual images.
24. The method according to any one of clauses 18 to 23, wherein evaluating the mura degree of the second virtual image further comprises:
   evaluating the mura degree of the second virtual image in luminance and color.
25. The method according to any one of clauses 17 to 24, wherein acquiring the mura feature of the first virtual image further comprises:
   acquiring a first polychrome virtual image rendered in the near-eye display; and
   acquiring the mura feature of the polychrome virtual image.
26. The method according to clause 25, wherein the first polychrome virtual image is acquired under a white test pattern.
27. The method according to any one of clauses 17 to 24, wherein acquiring the mura feature of the first virtual image further comprises:
   acquiring three monochrome primary (red, green and blue) virtual images rendered in the near-eye display; and
   acquiring the mura feature of each color monochrome image.
28. The method according to clause 27, wherein the three monochrome primary (red, green and blue) virtual images are acquired under red, green and blue test patterns, respectively.
29. A system for detecting a mura in a virtual image rendered in a near-eye display, comprising:
   an image generator configured to render a virtual image;
   an imager configured to acquire the virtual image;
   a positioner coupled with the image generator and the imager, and configured to control a relative position of the near-eye display and the imager; and
   a processor coupled with the imager and configured to evaluate a mura degree of the virtual image.
30. The system according to clause 29, wherein the processor is further configured to:
   extract a mura feature of the virtual image according to a mura type; and
   evaluate the mura degree of the virtual image based on the mura type.
31. The system according to clause 29, wherein the mura type comprises a corner mura, a cloud mura, or a global mura.
32. The system according to clause 31, wherein the processor is further configured to extracting the mura feature based on a luminance threshold profile in response to the mura feature being the corner mura.
33. The system according to clause 31, wherein the processor is further configured to extracting the mura feature based on a spatial gradient profile or frequency domain in response to the mura feature being the cloud mura.
34. The system according to clause 31, wherein the processor is further configured to extracting the mura feature based on global profile in response to the mura feature being the global mura.
35. The system according to clause 31, wherein the processor is further configured to:
   translate the virtual image into a pseudo-color image, wherein the pseudo-color image presents an absolute luminance distribution or a relative luminance distribution.
36. The system according to clause 31, wherein the processor is further configured to:
   plot the virtual image as a 3D surface to obtain a 3D image.
37. The system according to any one of clauses 31 to 36, wherein the processor is further configured to:
   determine one or more primary mura types of the virtual image; and
   evaluate the mura degree of the virtual image based on one or more preset thresholds corresponding to the one or more primary mura types.
38. The system according to clause 37, wherein the corner mura is determined as the primary mura type.
39. The system according to clause 38, wherein the one or more preset thresholds comprise:
   a luminance scale threshold corresponding to the corner mura, or an area size threshold corresponding to the cloud mura.
40. The system according to clause 39, wherein the preset threshold of the luminance scale threshold is 30%, and the preset threshold of the area size threshold is 30%.
41. The system according to any one of clauses 29 to 40, wherein the processor is further configured to perform a preprocessing to the virtual image.
42. The system according to clause 41, wherein the preprocessing is eliminating one or more of a noise or distortion.
43. The system according to any one of clauses 29 to 42, wherein the imager is further configured to acquiring the virtual image under a full white test pattern.
44. The system according to any one of clauses 29 to 42, wherein the imager is further configured to acquiring the virtual image under a full gray test pattern.
45. The system according to any one of clauses 29 to 44, wherein the imager comprises:
   a near-eye display lens configured to emulate a human eye for acquiring the virtual image; and
   a light measuring device configured to measure the virtual image.
46. The system according to clause 45, wherein the light measuring device comprises a colorimeter or an imaging camera.
47. The system according to clause 45, wherein the positioner is further configured to determine a spatial relation between the image generator and the light measuring device.
48. The system according to any one of clauses 29 to 47, wherein the image generator is further configured to render the virtual image under an ambient light condition.
49. The system according to any one of clauses 29 to 48, wherein the image generator is one of a micro-LED based display, a LCOS (Liquid Crystal on Silicon) display, or a DLP (Digital Light Processing) display.
50. The system according to any one of clauses 29 to 49, wherein the near-eye display is one of an augmented reality display, a virtual reality display, a Head-Up display or a Head-Mount display.
51. The system according to clause 50, wherein the near-eye display comprises the image generator and an optical combiner configured to project the virtual image from the image generator to a human eye.
52. A system for demura of a virtual image rendered in a near-eye display, comprising:
   an image generator configured to render a first virtual image;
   an imager configured to acquire the first virtual image;
   a positioner coupled with the image generator and the imager, and configured to control a relative position of the image generator and the imager;
   a mura feature extractor coupled with the imager and configured to extract a mura feature of the first virtual image;
   a compensation calculator coupled with the mura feature extractor, and configured to calculate a compensation factor; and
   a driver coupled with the compensation calculator and the image generator, and configured to adjust a gray scale value of the image generator based on the compensation factor to obtain a second virtual image.
53. The system according to clause 52, further comprising a preprocessor configured to perform a preprocessing to the first virtual image.
54. The system according to clause 53, wherein the preprocessing is eliminating one or more of a noise or a distortion.
55. The system according to clause 52, wherein the preprocessor is further configured to map a pixel matrix of the first virtual image to a source pixel matrix of the image generator.
56. The system according to any one of clauses 52 to 55, wherein the imager is configured to acquire monochrome virtual images for different colors for each individual channel of the first virtual image; and the mura feature extractor is further configured to acquire the mura feature of each of the monochrome virtual images.
57. The system according to clause 56, wherein the compensation calculator is configured to calculate the compensation factor based on the mura feature for each of the monochrome virtual images.
58. The system according to clause 57, wherein the compensation calculator is further configured to:
   obtain a color shift based on difference among the monochrome virtual images on a whole virtual image; and
   determine the color shift as the mura feature.
59. The system according to clause 58, wherein the difference is a doping ratio among the monochrome virtual images.
60. The system according to clause 52, wherein the compensation calculator is further configured to map a pixel matrix of the first virtual image to a source pixel matrix of the image generator.
61. The system according to any one of clauses 47 to 60, wherein the imager is further configured to acquire a first polychrome virtual image rendered by the image generator; and
   the mura feature extractor is further configured to acquire the mura feature of the virtual image.
62. The system according to clause 61, wherein the first polychrome virtual image is acquired under white test pattern.
63. The system according to clause 61, wherein the imager is further configured to acquire three monochrome primary (red, green and blue) virtual images rendered by the image generator.
64. The system according to clause 63, wherein the three monochrome primary (red, green and blue) virtual images are acquired under red, green and blue test patterns, respectively.
65. The system according to any one of clauses 52 to 64, wherein the image generator is further configured to render the first virtual image under an ambient light condition.
66. The system according to any one of clauses 52 to 65, wherein the mura feature extractor is further configured to extract the mura feature of the first virtual image according to a mura type, and the mura type comprises a corner mura, a cloud mura, or a global mura.
67. The system according to clause 66, wherein the mura feature extractor is further configured to:
   extract the mura feature based on a luminance threshold profile in response to the mura feature being the corner mura.
68. The system according to clause 66, wherein the mura feature extractor is further configured to:
   extracting the mura feature based on a spatial gradient profile or frequency domain in response to the mura feature being the cloud mura.
69. The system according to clause 66, wherein the mura feature extractor is further configured to:
   extracting the mura feature based on a global profile in response to the mura feature being the global mura.
70. The system according to clause 66, wherein the mura feature extractor is further configured to:
   translate the virtual image into a pseudo-color image, wherein the pseudo-color image presents an absolute luminance distribution or a relative luminance distribution.
71. The system according to clause 66, wherein the mura feature extractor is further configured to:
   plot the virtual image as a 3D surface to obtain a 3D image.
72. The system according to any one of clauses 66 to 71, further comprising an evaluator configured to evaluate the first virtual image and the second virtual image based on the mura type.
73. The system according to clause 72, wherein the evaluator is further configured to:
   determine one or more primary mura types of the first virtual image; and evaluate the mura degree of the second virtual image based on one or more preset thresholds corresponding to the one or more primary mura types.
74. The system according to clause 73, wherein the corner mura is determined as the primary mura type.
75. The system according to clause 73, wherein the one or more preset thresholds comprise:
   a luminance scale threshold corresponding to the corner mura, and
   an area size threshold corresponding to the cloud mura.
76. The system according to clause 75, wherein the preset threshold of the luminance scale threshold is 30%, and the preset threshold of the area size threshold is 30%.
77. The system according to any one of clauses 52 to 77, wherein the imager comprises:
   a near-eye display lens configured to emulate human eye for acquiring the virtual image; and
   a light measuring device configured measure the virtual image.
78. The system according to clause 77, wherein the light measuring device comprises a colorimeter or an imaging camera.
79. The system according to clause 78, wherein the positioner is further configured to determine a spatial relation between the image generator and the light measuring device.
80. The system according to any one of clauses 52 to 79, wherein the image generator is one of a micro-LED based display, a LCOS (Liquid Crystal on Silicon) display, or a DLP (Digital Light Processing) display.
81. The system according to any one of clauses 52 to 80, wherein the near-eye display is one of an augmented reality display, a virtual reality display, a Head-Up display or a Head-Mount display.
82. The system according to clause 81, wherein the near-eye display comprises the image generator and an optical combiner configured to project the virtual image from the image generator to a human eye.

In some embodiments, a non-transitory computer-readable storage medium including instructions is also provided, and the instructions may be executed by a device, for performing the above-described methods. Common forms of non-transitory media include, for example, a floppy disk, a flexible disk, hard disk, solid state drive, magnetic tape, or any other magnetic data storage medium, a CD-ROM, any other optical data storage medium, any physical medium with patterns of holes, a RAM, a PROM, and EPROM, a FLASH-EPROM or any other flash memory, NVRAM, a cache, a register, any other memory chip or cartridge, and networked versions of the same. The device may include one or more processors (CPUs), an input/output interface, a network interface, and/or a memory.

It should be noted that the relational terms herein such as “first” and “second” are used only to differentiate an entity or operation from another entity or operation, and do not require or imply any actual relationship or sequence between these entities or operations. Moreover, the words “comprising,” “having,” “containing,” and “including,” and other similar forms are intended to be equivalent in meaning and be open ended in that an item or items following any one of these words is not meant to be an exhaustive listing of such item or items, or meant to be limited to only the listed item or items.

As used herein, unless specifically stated otherwise, the term “or” encompasses all possible combinations, except where infeasible. For example, if it is stated that a database may include A or B, then, unless specifically stated otherwise or infeasible, the database may include A, or B, or A and B. As a second example, if it is stated that a database may include A, B, or C, then, unless specifically stated otherwise or infeasible, the database may include A, or B, or C, or A and B, or A and C, or B and C, or A and B and C.

It is appreciated that the above described embodiments can be implemented by hardware, or software (program codes), or a combination of hardware and software. If implemented by software, it may be stored in the above-described computer-readable media. The software, when executed by the processor can perform the disclosed methods. The computing units and other functional units described in this disclosure can be implemented by hardware, or software, or a combination of hardware and software. One of ordinary skill in the art will also understand that multiple ones of the above-described modules/units may be combined as one module/unit, and each of the above-described modules/units may be further divided into a plurality of sub-modules/sub-units.

In the foregoing specification, embodiments have been described with reference to numerous specific details that can vary from implementation to implementation. Certain adaptations and modifications of the described embodiments can be made. Other embodiments can be apparent to those skilled in the art from consideration of the specification and practice of the invention disclosed herein. It is intended that the specification and examples be considered as exemplary only, with a true scope and spirit of the invention being indicated by the following claims. It is also intended that the sequence of steps shown in figures are only for illustrative purposes and are not intended to be limited to any particular sequence of steps. As such, those skilled in the art can appreciate that these steps can be performed in a different order while implementing the same method.

In the drawings and specification, there have been disclosed exemplary embodiments. However, many variations and modifications can be made to these embodiments. Accordingly, although specific terms are employed, they are used in a generic and descriptive sense only and not for purposes of limitation.

What is claimed is:

1. A method for detecting a mura of a virtual image in a near-eye display, comprising:
acquiring the virtual image rendered in the near-eye display;
extracting a mura feature of the virtual image according to a mura type; and
evaluating a mura degree of the virtual image based on the mura type.

2. The method according to claim 1, wherein the mura type comprises a corner mura, a cloud mura, or a global mura.

3. The method according to claim 2, wherein extracting the mura feature of the virtual image according to the mura type, comprises:
extracting, when the mura type is the corner mura, the mura feature based on a luminance threshold profile.

4. The method according to claim 2, wherein extracting the mura feature of the virtual image according to the mura type, comprises:
extracting, when the mura type is the cloud mura, the mura feature based on a spatial gradient profile or frequency domain.

5. The method according to claim 2, wherein extracting the mura feature of the virtual image according to the mura type, comprises:
extracting, when the mura type is the global mura, the mura feature based on a global profile.

6. The method according to claim 2, wherein before extracting the mura feature of the virtual image according to the mura type, the method further comprises:
translating the virtual image into a pseudo-color image, wherein the pseudo-color image presents an absolute luminance distribution or a relative luminance distribution.

7. The method according to claim 2, wherein before extracting mura features of the virtual image based on the mura type, the method further comprises:
plotting the virtual image as a 3D surface to obtain a 3D image.

8. The method according to claim 2, wherein evaluating the mura degree of the virtual image based on the mura type, further comprising:
determining one or more primary mura types of the virtual image; and
evaluating the mura degree of the virtual image based on one or more preset thresholds corresponding to the one or more primary mura types.

9. The method according to claim 8, wherein the corner mura is determined as the primary mura type.

10. The method according to claim 9, wherein the one or more preset thresholds comprises:
a luminance scale threshold corresponding to the corner mura, or an area size threshold corresponding to the cloud mura.

11. The method according to claim 10, wherein the preset threshold of the luminance scale threshold is 30%, and the preset threshold of the area size threshold is 30%.

12. The method according to claim 1, wherein acquiring the virtual image rendered in the near-eye display, further comprises:
acquiring the virtual image under a solid test pattern or multiple partial test patterns, wherein the partial test patterns are with various gray values and colors.

13. The method according to claim 12, wherein the test pattern is a full white test pattern.

14. The method according to claim 12, wherein the test pattern is a full gray test pattern.

15. The method according to claim 12, wherein the virtual image is rendered under an ambient light condition.

16. The method according to claim 1, wherein before extracting the mura feature of the virtual image according to the mura type, the method further comprises:
preprocessing the virtual image by eliminating one or more of a noise or a distortion.

17. A system for detecting a mura in a virtual image rendered in a near-eye display, comprising:
an image generator configured to render a virtual image;
an imager configured to acquire the virtual image;
a positioner coupled with the image generator and the imager, and configured to control a relative position of the near-eye display and the imager; and
a processor coupled with the imager and configured to evaluate a mura degree of the virtual image.

18. The system according to claim 17, wherein the processor is further configured to:
extract a mura feature of the virtual image according to a mura type; and
evaluate the mura degree of the virtual image based on the mura type.

19. The system according to claim 18, wherein the mura type comprises a corner mura, a cloud mura, or a global mura.

20. The system according to claim 17, wherein the imager comprises:
a near-eye display lens configured to emulate a human eye for acquiring the virtual image; and
a light measuring device configured to measure the virtual image.
